(19) United States
(12) Patent Application Publication
(10) Pub. No.: US 2025/0364745 A1
(43) Pub. Date: Nov. 27, 2025

(54) HIGH-FREQUENCY, HIGH-CURRENT BOARD-TO-BOARD CONNECTORS

(71) Applicant: Amphenol Aorora Technology (Huizhou) Co., Ltd., Huizhou (CN)

(72) Inventors: Qi Han, Huizhou (CN); Xiaohong Zhu, Huizhou (CN)

(21) Appl. No.: 19/217,447

(22) Filed: May 23, 2025

(30) Foreign Application Priority Data
May 27, 2024 (CN) 202421179172.5

(51) Int. Cl. H01R 13/02; H01R 12/71; H01R 13/514; H01R 13/646; H01R 24/60

(52) U.S. Cl. CPC H01R 13/02; H01R 12/716; H01R 13/514; H01R 13/646; H01R 24/60

(57) ABSTRACT

High-frequency, high-current board-to-board connectors. A board-to-board connector system includes connectors configured to mate with each other. Each connector includes signal terminals capable of satisfying PCIe Gen 4.0's signal transmission requirements at 16 Gps, and power terminals capable of carrying a current of 5 A. For a receptacle connector, the signal terminals include mating ends aligned in an X direction and intermediate portions movable in a Y direction perpendicular to the X direction; and the power terminals include mating ends aligned in the Y direction and intermediate portions movable in both the X and Y directions. The receptacle housing includes outer walls surrounding a cavity, and an inner wall disposed in the cavity and separating the cavity into two slots. The plug housing include two inner walls configured to be inserted into the two slots in a mating direction a distance that can vary in a range of 0 to 0.6 mm.

### CROSS-REFERENCE TO RELATED APPLICATIONS

This application is claims priority to and the benefit of Chinese Patent Application No. 202421179172.5, filed on May 27, 2024. The contents of this application are incorporated herein by reference in their entirety.

### TECHNICAL FIELD

This application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors.

### SUMMARY

Aspects of the present disclosure relate to high-frequency, high-current board-to-board connectors.

Some embodiments relate to a receptacle connector. The receptacle connector may include a housing comprising a plurality of walls, and a cavity at least partially bounded by the plurality of walls; and a plurality of terminals, each of the plurality of terminals comprising a mating end, a tail end extending out of the cavity of the housing, and an intermediate portion between the mating end and the tail end, the intermediate portion disposed in the cavity of the housing, the plurality of terminals comprising a plurality of first terminals and a plurality of second terminals, the mating ends of the plurality of first terminals disposed in the cavity, the mating ends of the plurality of second terminals extending out of the cavity of the housing, the intermediate portions of the plurality of first terminals movable in a first direction, and the intermediate portions of the plurality of second terminals movable in both the first direction and a second direction perpendicular to the first direction.

Optionally, each of the plurality of first terminals comprises a plurality of curved segments each curving in the first direction; and each of the plurality of second terminals comprises a first curved segment curving in the second direction, and a second curved segment curving in the first direction.

Optionally, each of the plurality of curved segments of the plurality of first terminals bends at an obtuse angle.

Optionally, the first curved segment of each of the plurality of second terminals bends at an obtuse angle; and the second curved segment of each of the plurality of second terminals bends at a right angle.

Optionally, the intermediate portion of each of the plurality of second terminals comprises one or more gaps along its length direction.

Optionally, the plurality of first terminals are configured for signal transmission; and the mating ends of the plurality of first terminals are aligned in the second direction.

Optionally, the plurality of second terminals are configured for power transmission; and the mating ends of the plurality of second terminals are aligned in the first direction.

Optionally, a width of a gap between adjacent first terminals of the plurality of first terminals is less than a thickness of the plurality of first terminals.

Optionally, each of the plurality of first terminals is capable of satisfying PCIe Gen 4.0's signal transmission requirements at 16 Gps; each of the plurality of second terminals is capable of carrying a current of 5 A; and each of the plurality of terminals is movable in a range of −0.8 mm to +0.8 mm in the first direction.

Optionally, the plurality of first terminals are a first plurality of first terminals; the plurality of second terminals are a first plurality of second terminals; the plurality of terminals comprise a second plurality of first terminals and a second plurality of second terminals; the plurality of walls of the housing are a plurality of outer walls; the housing comprises an inner wall disposed in the cavity, the inner wall comprising two ends and two sides joining the two ends; the mating ends of the first and second plurality of first terminals are disposed along the two sides of the inner wall; and the mating ends of the first and second plurality of second terminals are disposed outside the two ends of the inner wall, respectively.

Some embodiments relate to a plug connector. The plug connector may include a housing comprising first and second outer walls facing each other, third and fourth outer walls joining the first and second outer walls and facing each other, a cavity at least partially bounded by the first, second, third and fourth outer walls, and first and second inner walls disposed in the cavity, the cavity comprising a first slot between the first inner wall and the first outer wall, a second slot between the first inner wall and the second inner wall, and a third slot between the second inner wall and the second outer wall; and a plurality of terminals, each of the plurality of terminals comprising a mating end disposed in the second slot of the cavity and along the first inner wall, a tail end extending out of the cavity of the housing, and an intermediate portion between the mating end and the tail end.

Optionally, each of the first, second, and third slots extend in a first direction; and the cavity comprises fourth and fifth slots disposed on opposite sides of the first, second, and third slots, each of the fourth and fifth slots extending in a second direction perpendicular to the first direction.

Optionally, the plurality of terminals are a plurality of first terminals; and the plug connector comprises a plurality of second terminals, each of the plurality of second terminals comprising a mating end disposed in the fourth slot and along the third outer wall, a tail end extending out of the cavity of the housing, and an intermediate portion between the mating end and the tail end.

Optionally, the plurality of first terminals are configured for signal transmission; the mating ends of the plurality of first terminals are aligned in the first direction; the plurality of second terminals are configured for power transmission; and the mating ends of the plurality of second terminals are aligned in the second direction.

Optionally, the plurality of first terminals are a first plurality of first terminals; the plurality of second terminals are a first plurality of second terminals; and the plug connector comprises a second plurality of first terminals and a second plurality of second terminals, each of the second plurality of first terminals comprising a mating end disposed in the second slot of the cavity and along the second inner wall, each of the plurality of second terminals comprising a mating end disposed in the fifth slot and along the fourth outer wall.

Optionally, the first inner wall is connected to the first outer wall at a bottom of the first slot and corresponding to intermediate portions of the first plurality of first terminals; and the second inner wall is connected to the second outer wall at a bottom of the second slot and corresponding to intermediate portions of the second plurality of first terminals.

Some embodiments relate to a board-to-board connector system. The board-to-board connector system may include a receptacle connector and a plug connector. The receptacle connector may include a receptacle housing comprising first and second outer walls facing each other, third and fourth outer walls joining the first and second outer walls and facing each other, an inner wall, a first slot between the first outer wall and the inner wall, and a second slot between the second outer wall and the inner wall. The plug connector may include a plug housing comprising a plurality of outer walls configured to be disposed outside the outer walls of the receptacle connector, and first and second inner walls configured to insert into the first and second slots of the receptacle connector in a mating direction a distance that can vary in a range of 0 to 0.6 mm.

Optionally, the plug housing comprise a first slot between the first and second inner walls and elongated in a first direction, second and third slots on opposite sides of the first slot and elongated in a second direction perpendicular to the first direction; the inner wall of the receptacle housing is configured to be disposed in the first slot of the plug housing; and the third and fourth outer walls are configured to be disposed in the second and third slots of the plug housing, respectively.

Optionally, the plug connector comprises a plurality of plug signal terminals and plurality of plug power terminals, each of the plurality of plug signal terminals comprising a mating end disposed in the first slot and along the first or second inner wall, each of the plurality of plug power terminals comprising a mating end disposed in the second or third slots.

Optionally, the receptacle connector comprises a plurality of receptacle signal terminals and a plurality of receptacle power terminals, each of the plurality of receptacle signal terminals comprising a mating end disposed on a side of the inner wall, each of the plurality of receptacle power terminals comprising a mating end disposed outside the third or fourth outer walls; intermediate portions of the plurality of receptacle signal terminals are movable in the second direction; and intermediate portions of the plurality of receptacle power terminals are movable in both the first direction and the second direction.

Some embodiments relate to a floating high-current connector system. The connector system may include a plug connector and a receptacle connector, wherein the plug connector and the receptacle connector may be plugged into each other for connection. The receptacle connector may comprise a receptacle housing, a plurality of receptacle power terminals and a plurality of receptacle signal terminals. The receptacle power terminals and the receptacle signal terminals may be held by the receptacle housing. Each receptacle power terminal may comprise a mating end, an elastic intermediate portion and a contact tail connected in sequence. The mating end may be electrically connected to the plug connector. The elastic intermediate portion may include a gap along its length. Two ends of the gap may be connected to the mating end and the contact tail, respectively. The elastic intermediate portion comprises a plurality of first curved segments curving in a first direction and a plurality of second curved segments curving in a second direction, the first direction and the second direction being perpendicular to each other.

Optionally, a connection between the elastic intermediate portion and the contact tail is at a right angle.

Optionally, the first curved segments and the second curved segments bend at obtuse angles.

Optionally, the receptacle signal terminals comprise a plurality of first curved segments, and the first curved segments bend at obtuse angles.

Optionally, a rounded corner is formed at a bending position of the first curved segment.

Optionally, the plug connector comprises a plug housing, a plurality of plug power terminals and a plurality of plug signal terminals, and the plug power terminals and the plug signal terminals are held by the plug housing; and each of the plug power terminals is electrically connected to one of the mating ends, and each of the plug signal terminals is electrically connected to one of the receptacle signal terminals.

Optionally, the plurality of plug signal terminals are arranged in two rows at equal intervals in a mirror image configuration, and the plurality of receptacle signal terminals are arranged in two rows at equal intervals in a mirror image configuration.

Optionally, a width of a space between adjacent plug signal terminals in each row of the plug signal terminals is less than a thickness of the plug signal terminals, and a width of a space between adjacent receptacle signal terminals in each row of the receptacle signal terminals is less than a thickness of the receptacle signal terminals.

Optionally, one of the plug power terminals is symmetrically distributed at each of the opposite ends of each row of the plug signal terminals, and one of the receptacle power terminals is symmetrically distributed at each of the opposite ends of each row of the receptacle signal terminals.

Optionally, a first cavity and two inner walls disposed in the first cavity are at a top of the plug housing, each of the plug power terminals is correspondingly disposed on opposite sides of the first cavity, and two rows of the plug signal terminals correspondingly line along the two inner walls; and outer walls configured to be inserted into the first cavity, and two second slots disposed between the outer wall and configured to receive the inner walls, are at a top of the receptacle housing, each of the mating ends lines along opposite sides of the outer wall, and two rows of the receptacle signal terminals correspondingly line along the two second slots.

These techniques may be used alone or in any suitable combination. The foregoing summaries are provided by way of illustration and are not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1A is a perspective view of a board-to-board connector system comprising a plug connector and a receptacle connector, according to some embodiments, showing the plug connector and receptacle connector separately.

FIG. 1B is an elevation view of the board-to-board connector system of FIG. 1A, showing the plug connector and receptacle connector at least partially mated with each other.

FIG. 2 is a perspective view of a receptacle power terminal of the receptacle connector of the board-to-board connector system of FIG. 1A.

FIG. 3 is a perspective view of the receptacle power terminal of FIG. 2, with a first curved segment and a second curved segment labeled.

FIG. 4 is a perspective view of a receptacle signal terminal of the receptacle connector of the board-to-board connector system of FIG. 1A.

FIG. 5A is a perspective view of the plug connector of the board-to-board connector system of FIG. 1A.

FIG. 5B is a cross-sectional perspective view of the plug connector of FIG. 5A along a line marked “5B-5B” in FIG. 5A.

FIG. 6 is a perspective view of the plug connector of FIG. 5A, with a plug housing hidden and showing plug power terminals and plug signal terminals.

FIG. 7 is a perspective view of the receptacle connector of the board-to-board connector system of FIG. 1A, with a receptacle housing hidden and showing receptacle power terminals and receptacle signal terminals.

FIG. 8 is a perspective view of the plug connector of FIG. 5A.

FIG. 9A is a perspective view of the receptacle connector of the board-to-board connector system of FIG. 1A.

FIG. 9B is an exploded perspective view of the receptacle housing of the receptacle connector of FIG. 9A, showing an inner housing portion and an outer housing portion.

FIG. 10A is a cross-sectional perspective view of the board-to-board connector system of FIG. 1B along a line marked “10A-10A” in FIG. 1A.

FIG. 10B is a cross-sectional perspective view of the board-to-board connector system of FIG. 1B along a line marked “10B-10B” in FIG. 1B.

FIG. 10C is a cross-sectional perspective view of the board-to-board connector system of FIG. 1B along a line marked “10C-10C” in FIG. 1B.

FIG. 10D is a cross-sectional perspective view of the board-to-board connector system of FIG. 1B along a line marked “10D-10D” in FIG. 1B.

### DETAILED DESCRIPTION

The inventors have recognized and appreciated techniques for making board-to-board connectors capable of providing both high-frequency signal transmission and high-current power transmission for use in a harsh environment such as one presented by an automobile. Techniques described herein may enable connectors that have signal terminals capable of satisfying PCIe Gen 4.0's signal transmission requirements at 16 Gps, and power terminals capable of carrying a high current (e.g., 5 A), while satisfying reliability requirements of industry standards (e.g., USCAR-2-V2) with floating terminals capable of moving to accommodate manufacturing and/or assembling variation. Techniques described herein may also enable a connector system capable of reliably operating in a range of heights. For example, a plug connector may be configured for inserting into a receptacle connector in a mating direction by a distance that can vary in a range of 0 to 0.60 mm. For example, if the nominal mating height (fully mated) of a system is 26.00 mm, the system can operate reliably in a mating height range of 26.00 mm to 26.60 mm.

According to aspects of the present disclosure, a board-to-board connector system may include a receptacle connector and a plug connector. In some embodiments, the connectors may be mounted to circuit boards, respectively, and then mated to electrically connect the circuit boards. The connectors may be configured to allow for ±0.8 mm floating tolerance during, for example, mating to accommodate manufacturing and/or assembling variations. The connectors may have terminals capable of carrying a current of up to 5 A.

In some embodiments, the receptacle connector may include a receptacle housing and signal and power terminals held by the receptacle housing. The receptacle signal terminals may include mating ends aligned in an X direction and intermediate portions movable in a Y direction perpendicular to the X direction. In some embodiments, the intermediate portion of each receptacle signal terminal may include a plurality of curved segments curving in the Y direction. Each curved segment curving in the second direction may bend at an obtuse angle.

The receptacle power terminals may include mating ends aligned in the Y direction and intermediate portions movable in both the X and Y directions. In some embodiments, the intermediate portion of each receptacle power terminal may include one or more curved segments curving in the X direction and one or more curved segments curving in the Y direction. Each curved segment curving in the X direction may bend at an obtuse angle. Each curved segment curving in the Y direction may bend at a right angle. The intermediate portion of the receptacle power terminals may include one or more gaps that help distribute stress during floating and allow the receptacle power terminal to quickly return to their original state after the floating, ensuring a stable connection. This configuration may also enhance the current transmission rate of the receptacle power terminals.

In some embodiments, the plug connector may include a plug housing and plug signal and power terminals held by the plug housing. The plug signal terminals may include mating ends aligned in an X direction and configured to mate with the receptacle signal terminals. The plug power terminals may include mating ends aligned in the Y direction and configured to mate with the receptacle power terminals.

In some embodiments, the receptacle housing and the plug housing may be configured to enable a range of reliable insertion distance. In some embodiments, the receptacle housing may include outer walls surrounding a cavity, and an inner wall disposed in the cavity and separating the cavity into two slots. The plug housing may include two inner walls configured to be inserted into the two slots in a mating direction a distance that can vary in a range of 0 to 0.6 mm.

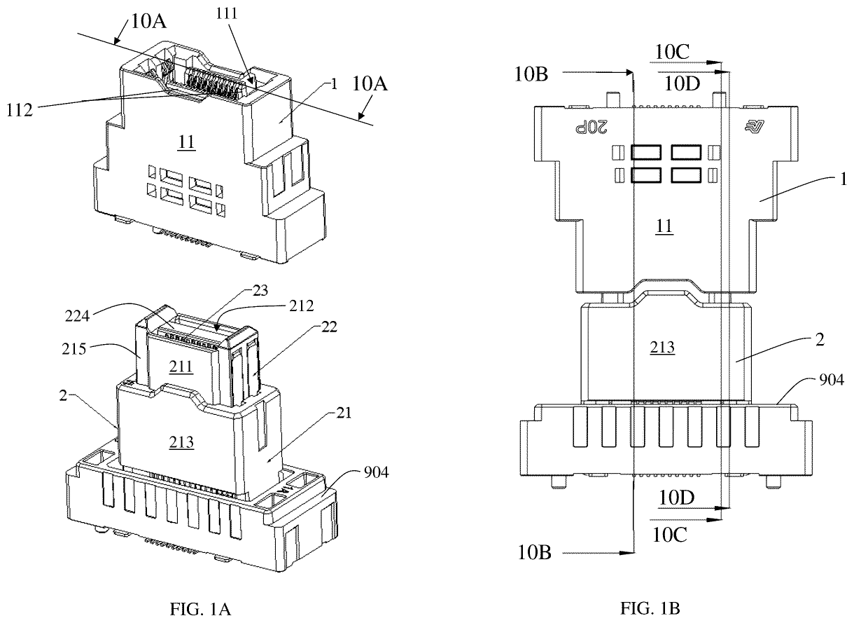

FIG. 1A is a perspective view of a board-to-board connector system comprising a plug connector 1 and a receptacle connector 2, showing the plug connector and receptacle connector separately. FIG. 1B is an elevation view of the board-to-board connector system of FIG. 1A, showing the plug connector 1 and receptacle connector 2 at least partially mated with each other. The plug connector 1 may be mounted onto a first circuit board (not shown). The receptacle connector 2 may be mounted onto a second circuit board (not shown). Circuits on the first and second circuit boards may be connected through the plug and receptacle connectors.

In the illustrated embodiment, the receptacle connector 2 includes a receptacle housing 21, a plurality of receptacle power terminals 22 and a plurality of receptacle signal terminals 23. The receptacle power terminals 22 and the receptacle signal terminals 23 are held by the receptacle housing 21. The receptacle power terminals 22 are configured for current transmission, and the receptacle signal terminals 23 are configured for signal transmission.

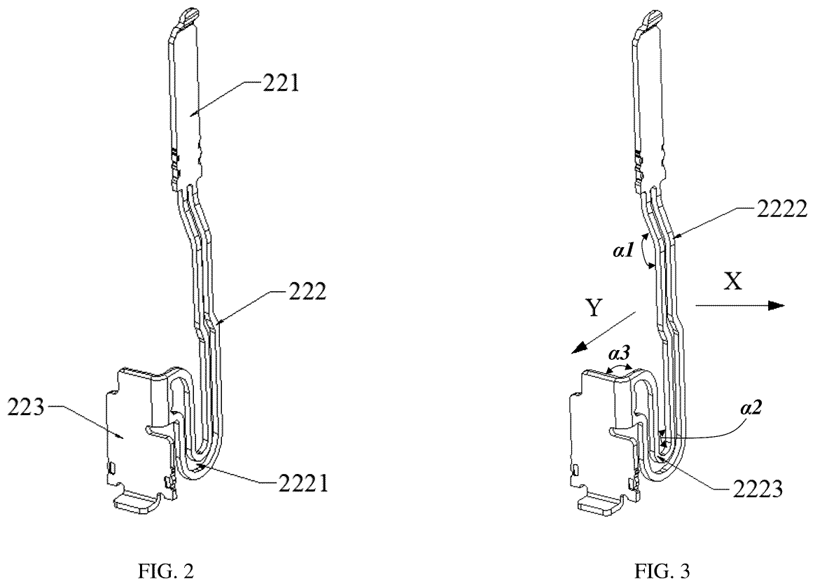

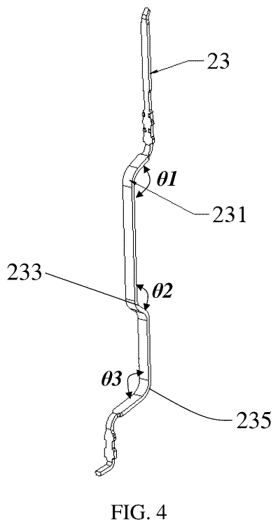

FIGS. 2 and 3 are perspective views of a receptacle power terminal 23. As illustrated, the receptacle power terminal 22 includes a mating end 221, an intermediate portion 222 and a contact tail 223 connected in sequence. The mating end 221 is configured to be electrically connected to the plug connector 1. The intermediate portion 222 can meet the floating requirements when the plug connector 1 is inserted into the receptacle connector 2 and provide additional tolerance for manufacturing and assembling. The contact tail 223 is configured for mounting on a circuit board.

As illustrated, the intermediate portion 222 may include a gap 2221 along its length. Two ends of the gap 2221 are connected to the mating end 221 and the contact tail 223, respectively. In some embodiments, the gap 2221 may cover the entire length direction of the intermediate portion 222, and in some embodiments, there may be one or more gaps 2221. By providing the gap 2221 in the intermediate portion 222 of the receptacle power terminal 22, the stress of the receptacle power terminal 22 during movement can be dispersed, so that the receptacle power terminal 22 can quickly return to its original state after the movement, realizing stable connection and transmission. The provision of the gap 2221 may improve the current transmission rate, realizing high-current transmission of the connector system.

As illustrated, a plurality of first curved segments 2222 are formed on the intermediate portion 222 in an X direction. A plurality of second curved segments 2223 are formed on the intermediate portion 222 in a Y direction. The X direction and the Y direction may be substantially perpendicular to each other. Each first curved segment 2222 may bend at an obtuse angle a1. Each second curved segment may bend at a right angle a2.

By forming a plurality of first curved segments 2222 and a plurality of second curved segments 2223 in the X direction and the Y direction, respectively, floating spaces in two different directions can be simultaneously provided for the receptacle power terminal 22. The receptacle power terminal 22 may have a floating range during mating with the plug connector, such as +0.80 mm in both the X and Y direction. The tolerance during assembly can be better absorbed, realizing stable current transmission. Also, the plurality of first curved segments 2222 and the plurality of second curved segments 2223 respectively formed in different directions can further significantly improve the current transmission rate, so that the receptacle power terminal 22 can carry a high current to meet the requirements of high-current transmission.

As illustrated,, the connection between the intermediate portion 222 and the contact tail 223 is at a right angle a3. On the basis that a plurality of first curved segments 2222 and a plurality of second curved segments 2223 are formed on the intermediate portion 222 in the X direction and the Y direction, respectively, the right-angle structure formed between the intermediate portion 222 and the contact tail 223 can further increase the current transmission rate, so that the connector system realizes stable high-current transmission, and a current that the receptacle power terminal 22 can carry may be as high as 5 A.

As illustrated, the first curved segments 2222 and the second curved segments 2223 may bend at angles. The first curved segment 2222 and the second curved segment 2223 with bending angles can provide elongated extension space for the floating of the receptacle power terminal 22 while further facilitating recovery after the floating ends. In some embodiments, rounded corners may be formed at bending positions of the first curved segment 2222 and the second curved segment 2223, which can also be understood as both the first curved segment 2222 and the second curved segment 2223 being arc-shaped bends. The rounded corner structure can disperse the stress of the receptacle power terminal 22 when floating, so that the receptacle power terminal 22 can quickly return to its original state after the floating ends, thereby realizing rapid assembly and stable connection.

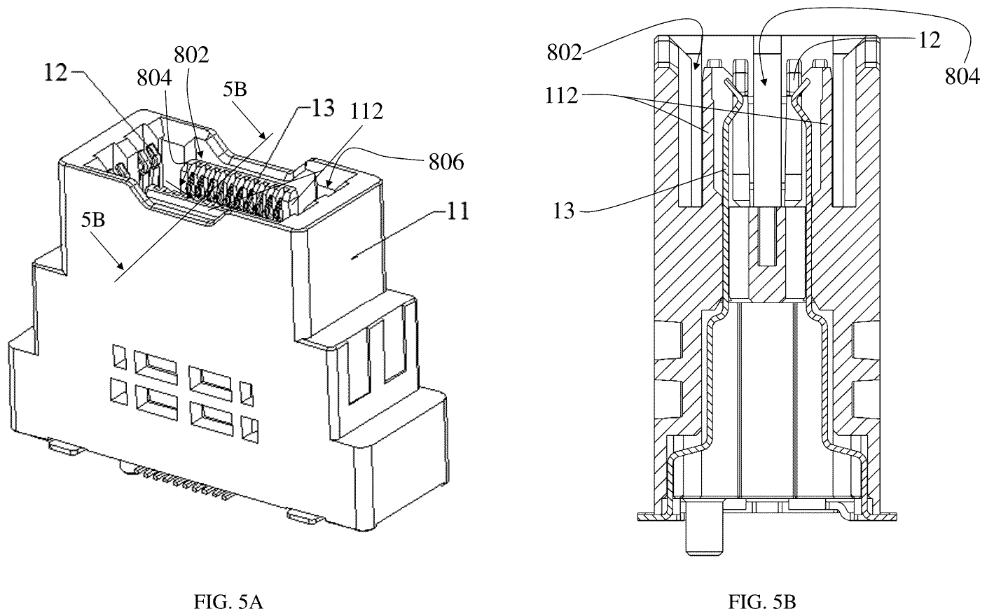

FIG. 4 is a perspective view of a receptacle signal terminal 23. The receptacle signal terminal may include a plurality of curved segments. As illustrated, the receptacle signal terminal may include a first curved segments 231, a second curved segment 233, and a third curved segment 235. The first curved segment may bend at an obtuse angle θ1. The second curved segment may bend at an obtuse angle θ2. The third curved segment may bend at an obtuse angle θ3. A plurality of curved segments formed by the receptacle signal terminal 23 can provide more elongated extension space for the floating of the receptacle signal terminal 23. The obtuse bending angles further facilitate recovery after the floating ends. In some embodiments, a rounded corner is formed at a bending position of the first curved segment 231, which can also be understood as the first curved segment 231 being an arc-shaped bend. The rounded corner can disperse the stress of the receptacle signal terminal 23 when floating, which facilitates rapid recovery after the floating ends.

With the floating space provided by the curved segments, when the plug connector 1 and the receptacle connector 2 are mated with each other, they are allowed to be plugged shallowly or deeply by 0.60 mm. For example, when the minimum matching height of the plug connector 1 and the receptacle connector 2 is 26.0 mm, the maximum matching height may reach 26.60 mm, thereby making the connector system have higher versatility and inclusiveness.

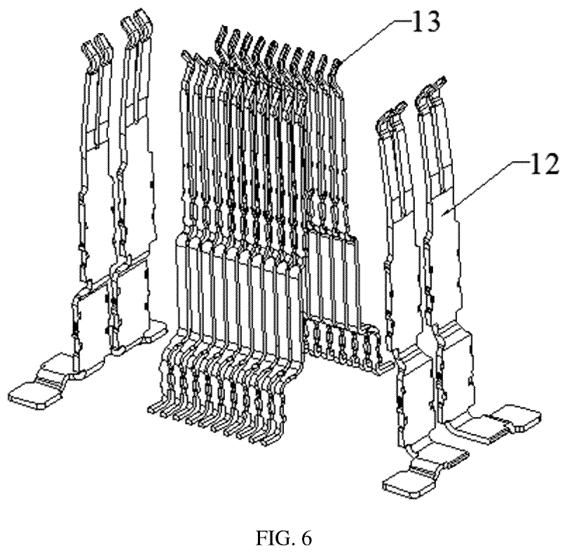

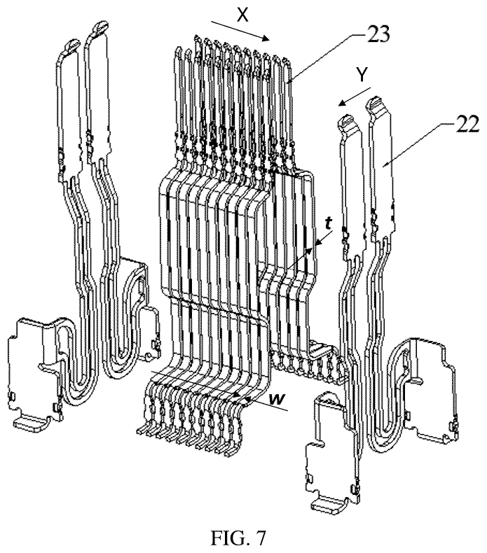

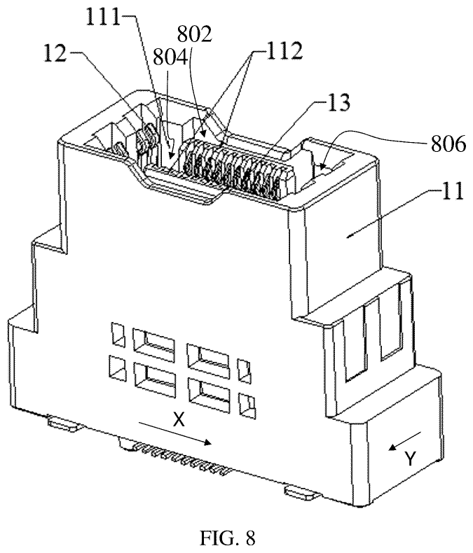

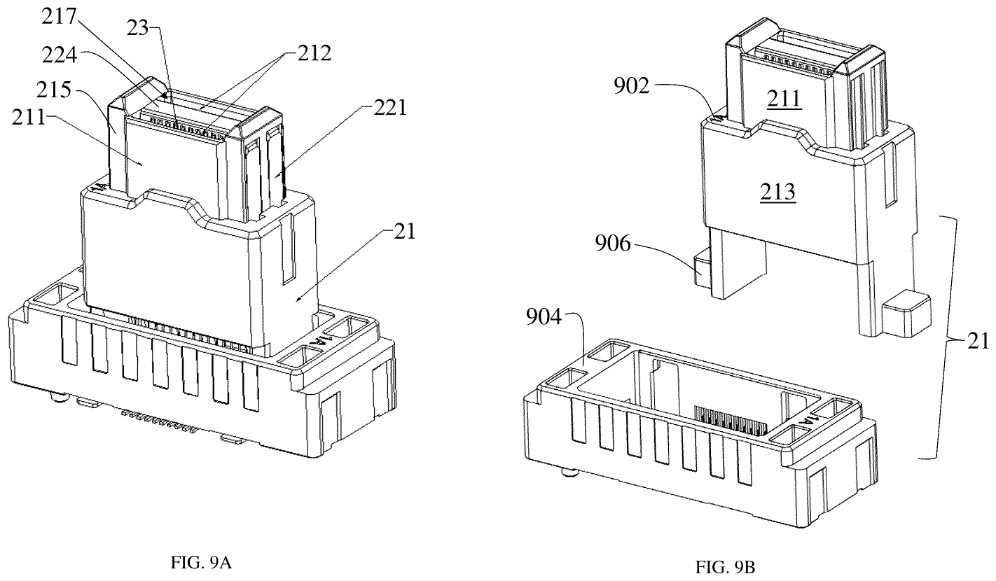

FIGS. 5A and 8 are perspective views of the plug connector 1. FIG. 5B is a cross-sectional perspective view of the plug connector I along a line marked “5B-5B” in FIG. 5B. FIG. 6 is a perspective view of the plug connector 1, with the plug housing 11 hidden and showing the plug power terminals 12 and plug signal terminals 13. FIG. 7 is a perspective view of the receptacle connector 2, with the receptacle housing 21 hidden and showing receptacle power terminals 22 and receptacle signal terminals 23.

As illustrated, the plug connector I includes a plug housing 11, a plurality of plug power terminals 12 and several plug signal terminals 13. The plug power terminals 12 and the plug signal terminals 13 are held by the plug housing 11. Each plug power terminal 12 is configured to be correspondingly electrically connected to one mating end 221. Each plug signal terminal 13 is configured to be correspondingly electrically connected to one receptacle signal terminal 23.

In some embodiments, multiple curved segments may be formed on each of the plug power terminal 12 and the plug signal terminal 13. Each curved segment may bend at an obtuse angle.

As illustrated, a plurality of plug signal terminals 13 are arranged in two rows at equal intervals in a mirror image configuration. A plurality of receptacle signal terminals 23 are arranged in two rows at equal intervals in a mirror image configuration. In some embodiments, a width of a space between adjacent plug signal terminals 13 in each row of plug signal terminals 13 is less than the thickness of the plug signal terminals 13. A width w of a space between adjacent receptacle signal terminals 23 in each row of receptacle signal terminals 23 is less than the thickness t of the receptacle signal terminals 23. The width of a space between adjacent plug signal terminals 13 is less than the thickness of the plug signal terminals 13, thereby realizing a close arrangement between the plug signal terminals 13. The width of a space between adjacent receptacle signal terminals 23 is less than the thickness of the receptacle signal terminals 23, thereby realizing a close arrangement between the receptacle signal terminals 23. Therefore, high-frequency and high-speed transmission of signals is realized, so that the connector system can meet PCIe Gen4.0 16 Gbps high-speed transmission.

As illustrated, one plug power terminal 12 is symmetrically distributed at each of the opposite ends of each row of plug signal terminals 13. One receptacle power terminal 22 is symmetrically distributed at each of the opposite ends of each row of receptacle signal terminals 23. In some embodiments, two plug power terminals 12 respectively disposed at two ends of each row of plug signal terminals 13 are in a mirror-image configuration. Two receptacle power terminals 22 respectively disposed at two ends of each row of receptacle signal terminals 23 are also in a mirror-image configuration.

As illustrated, a cavity 111 and two inner walls 112 disposed in cavity 111 are formed at the top of the plug housing 11. Each plug power terminal 12 is correspondingly disposed on opposite sides of cavity 111. Two rows of plug signal terminals 13 correspondingly line along the two inner walls 112. In some embodiments, two rows of plug signal terminals 13 correspondingly line along sides of the two inner walls 112, and plug power terminals 12 correspondingly line along opposite sides of the cavity 111 which are disposed at the opposite ends of the inner wall 112.

In some embodiments, one end of the plug power terminal 12 is disposed along an inner wall of the cavity 111 for realizing electrical connection with the mating end 221, and the other end passes through the bottom of the cavity 111 and is mounted at a bottom position of the plug housing 11 and configured for mounting on the circuit board. One end of the plug signal terminal 13 is disposed along a side of the inner wall 112 for realizing electrical connection with the receptacle signal terminal 23, and the other end passes through the bottom of the cavity 111 and is mounted at a bottom position of the plug housing 11 and configured for mounting on the circuit board.

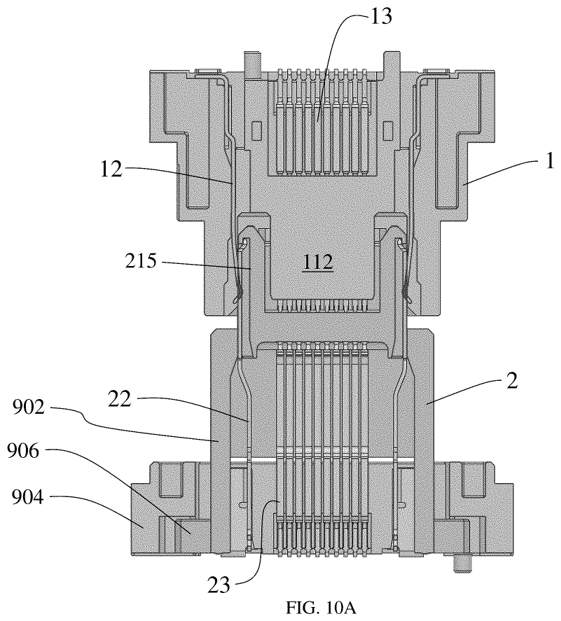

FIG. 9A is a perspective view of the receptacle connector 2. FIG. 9B is an exploded view of the receptacle housing 21 of the receptacle connector 2. Outer walls 211 and inner wall 224 configured to be inserted into the cavity 111, and two slots 212 disposed between the outer walls 211 and configured to receive the inner walls 112, are formed at the top of the receptacle housing 21. Mating ends 221 correspondingly line along opposite sides of the outer wall 211, and two rows of receptacle signal terminals 23 correspondingly line along the two slots 212. In some embodiments, the intermediate portion 222 is mounted below the outer wall 211 and inside the receptacle housing 21. The contact tail 223 is mounted at a bottom position of the receptacle housing 21 and configured for mounting on the circuit board. One end of the receptacle signal terminal 23 is disposed along the inner wall 224 for electrical connection with the plug signal terminal 13, and the other end passes through the bottom of the slot 212 and is mounted at a bottom position of the receptacle housing 21 and configured mounting on the circuit board. In some embodiments, the receptacle housing 21 may include an outer housing portion 904 and an inner housing portion 902. The outer housing portion 904 may be sleeved outside the inner housing portion 902. The inner housing portion 902 may include protrusions 906 configured to movably engage the outer housing portion 904. A gap generated by inserting and mating of the plug housing 11 and the receptacle housing 21 may be small, enabling the connector system to meet the vibration environment requirements of USCAR-2-V2.

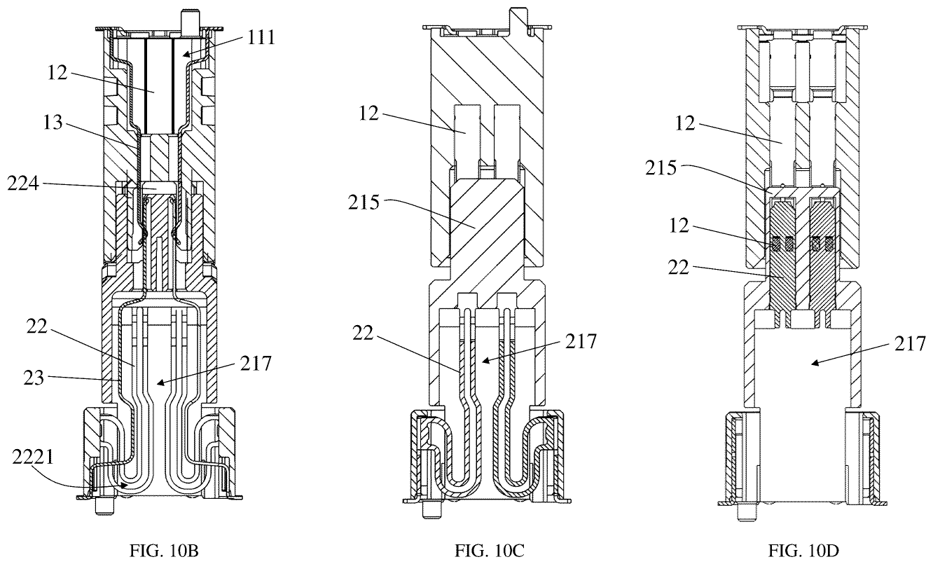

FIG. 10A is a cross-sectional perspective view of the board-to-board connector system along a line marked “10A-10A” in FIG. 1A. FIG. 10B is a cross-sectional perspective view of the board-to-board connector system long a line marked “10B-10B” in FIG. 1B. FIG. 10C is a cross-sectional perspective view of the board-to-board connector system along a line marked “10C-10C” in FIG. 1B. FIG. 10D is a cross-sectional perspective view of the board-to-board connector system along a line marked “10D-10D” in FIG. 1B. In the floating high-current connector system of the present disclosure, the intermediate portions of receptacle power terminals 22 may include the gaps 2221, which may disperse the stress when floating, and facilitates the improvement of the current transmission rate. By forming a plurality of curved segments on the intermediate portion in the X direction and the Y direction, respectively, more floating space is provided for the receptacle power terminal 22, the tolerance during assembling/mating is better absorbed, and the current transmission rate can be increased to meet the requirements of high-current transmission. The connection between the intermediate portion 222 and the contact tail 223 is at a right angle, which further increases the current transmission rate, so that the receptacle power terminal can carry a high current as high as 5A, realizing the high-current transmission of the connector system. By forming a plurality of curved segments on the receptacle signal terminal 23, more floating space can be provided for the receptacle signal terminal. Each curved segment may bend at an obtuse angle, and a rounded corner may be formed on a bending position, which can disperse the stress when floating and facilitate rapid recovery after the floating ends. The width of a space between adjacent plug signal terminals 13 is less than the thickness of the plug signal terminal, and the width of a space between adjacent receptacle signal terminals 23 is less than the thickness of the receptacle signal terminal, which can realize high-speed signal transmission.

Various aspects are described in this disclosure, which include, but are not limited to, the following aspects:

1. A floating high-current connector system comprising a plug connector (e.g., 1) and a receptacle connector (e.g., 2), wherein the plug connector (e.g., 1) and the receptacle connector (e.g., 2) are plugged into each other for connection; the receptacle connector (e.g., 2) comprises a receptacle housing (e.g., 21), a plurality of receptacle power terminals (e.g., 22) and a plurality of receptacle signal terminals (e.g., 23), and the receptacle power terminals (e.g., 22) and the receptacle signal terminals (e.g., 23) are held by the receptacle housing (e.g., 21); each receptacle power terminal (e.g., 22) comprises a mating end (e.g., 221), an elastic intermediate portion (e.g., 222) and a contact tail connected in sequence (e.g., 223), and the mating end (e.g., 221) is electrically connected to the plug connector (e.g., 1); the elastic intermediate portion (e.g., 222) comprises a gap (e.g., 2221) along its length, and two ends of the gap (e.g., 2221) are connected to the mating end (e.g., 221) and the contact tail (e.g., 223), respectively; and the clastic intermediate portion (e.g., 222) comprises a plurality of first curved segments (e.g., 2222) curving in a first direction (e.g., X), and a plurality of second curved segments (e.g., 2223) curving in a second direction (e.g., Y), the first direction (e.g., X) and the second direction (e.g., Y) being perpendicular to each other.

2. The floating high-current connector system according to aspect 1, wherein a connection between the elastic intermediate portion (e.g., 222) and the contact tail (e.g., 223) is at a right angle.

3. The floating high-current connector system according to aspect 1, wherein the first curved segments (e.g., 2222) and the second curved segments (e.g., 2223) bend at obtuse angles.

4. The floating high-current connector system according to aspect 1, wherein the receptacle signal terminals (e.g., 23) comprise a plurality of first curved segments (e.g., 231), and the first curved segments (e.g., 231) bend at obtuse angles.

5. The floating high-current connector system according to aspect 4, wherein a rounded corner is formed at a bending position of the first curved segment (e.g., 231).

6. The floating high-current connector system according to aspect 1, wherein the plug connector (e.g., 1) comprises a plug housing (e.g., 11), a plurality of plug power terminals (e.g., 12) and a plurality of plug signal terminals (e.g., 13), and the plug power terminals (e.g., 12) and the plug signal terminals (e.g., 13) are held by the plug housing (e.g., 11); and each of the plug power terminals (e.g., 12) is electrically connected to one of the mating ends (e.g., 221), and each of the plug signal terminals (e.g., 13) is electrically connected to one of the receptacle signal terminals (e.g., 23).

7. The floating high-current connector system according to aspect 6, wherein the plurality of plug signal terminals (e.g., 13) are arranged in two rows at equal intervals in a mirror image configuration, and the plurality of receptacle signal terminals (e.g., 23) are arranged in two rows at equal intervals in a mirror image configuration.

8. The floating high-current connector system according to aspect 7, wherein a width of a space between adjacent plug signal terminals (e.g., 13) in each row of the plug signal terminals (e.g., 13) is less than a thickness of the plug signal terminals (e.g., 13), and a width of a space between adjacent receptacle signal terminals (e.g., 23) in each row of the receptacle signal terminals (e.g., 23) is less than a thickness of the receptacle signal terminals (e.g., 23).

9. The floating high-current connector system according to aspect 7, wherein one of the plug power terminals (e.g., 12) is symmetrically distributed at each of the opposite ends of each row of the plug signal terminals (e.g., 13), and one of the receptacle power terminals (e.g., 22) is symmetrically distributed at each of the opposite ends of each row of the receptacle signal terminals (e.g., 23).

10. The floating high-current connector system according to aspect 9, wherein a first cavity (e.g., 111) and two inner walls (e.g., 112) disposed in the first cavity (e.g., 111) are at a top of the plug housing (e.g., 11), the plug power terminals (e.g., 12) line along opposite sides of the first cavity (e.g., 111), and two rows of the plug signal terminals (e.g., 13) correspondingly line along the two inner walls (e.g., 112); and outer walls (e.g., 211) configured to be inserted into the first cavity (e.g., 111), and second slots (e.g., 212) disposed between the outer walls (e.g., 211) and configured to receive the inner walls (e.g., 112), are at a top of the receptacle housing (e.g., 21), each of the mating ends (e.g., 221) line along opposite sides of the outer wall (e.g., 211), and two rows of the receptacle signal terminals (e.g., 23) correspondingly line along the two second slots (e.g., 212).

11. A receptacle connector (e.g., 2) comprising a housing (e.g., 21) comprising a plurality of walls (e.g., 211), and a cavity (e.g., 217) at least partially bounded by the plurality of walls; and a plurality of terminals, each of the plurality of terminals comprising a mating end (e.g., 221), a tail end (e.g., 223) extending out of the cavity of the housing, and an intermediate portion (e.g., 222) between the mating end and the tail end, the intermediate portion disposed in the cavity of the housing, the plurality of terminals comprising a plurality of first terminals (e.g., 23) and a plurality of second terminals (e.g., 22), the mating ends of the plurality of first terminals disposed in the cavity, the mating ends of the plurality of second terminals extending out of the cavity of the housing, the intermediate portions of the plurality of first terminals movable in a first direction (e.g., Y direction), and the intermediate portions of the plurality of second terminals movable in both the first direction and a second direction (e.g., X direction) perpendicular to the first direction.

12. The receptacle connector of aspect 11, wherein each of the plurality of first terminals comprises a plurality of curved segments (e.g., 231, 233, 235) each curving in the first direction; and each of the plurality of second terminals comprises a first curved segment (e.g., 2222) curving in the second direction, and a second curved segment (e.g., 2223) curving in the first direction.

13. The receptacle connector of aspect 12, wherein each of the plurality of curved segments of the plurality of first terminals bends at an obtuse angle (e.g., θ1, θ2, θ3).

14. The receptacle connector of aspect 12, wherein the first curved segment (e.g., 2222) of each of the plurality of second terminals bends at an obtuse angle (e.g., α1); and the second curved segment (e.g., 2223) of each of the plurality of second terminals bends at a right angle (e.g., α2).

15. The receptacle connector of aspect 14, wherein the intermediate portion of each of the plurality of second terminals comprises one or more gaps (e.g., 2221) along its length direction.

16. The receptacle connector of aspect 11, wherein the plurality of first terminals are configured for signal transmission; and the mating ends of the plurality of first terminals are aligned in the second direction.

17. The receptacle connector of aspect 16, wherein the plurality of second terminals are configured for power transmission; and the mating ends of the plurality of second terminals are aligned in the first direction.

18. The receptacle connector of aspect 17, wherein a width (e.g., w) of a gap between adjacent first terminals of the plurality of first terminals is less than a thickness (e.g., t) of the plurality of first terminals.

19. The receptacle connector of aspect 18, wherein each of the plurality of first terminals is capable of satisfying PCIe Gen 4.0's signal transmission requirements at 16 Gps; each of the plurality of second terminals is capable of carrying a current of 5 A; and each of the plurality of terminals is movable in a range of −0.8 mm to +0.8 mm in the first direction.

20. The receptacle connector of aspect 19, wherein the plurality of first terminals are a first plurality of first terminals; the plurality of second terminals are a first plurality of second terminals; the plurality of terminals comprise a second plurality of first terminals and a second plurality of second terminals; the plurality of walls of the housing are a plurality of outer walls; the housing comprises an inner wall (e.g., 224) disposed in the cavity, the inner wall comprising two ends and two sides joining the two ends; the mating ends of the first and second plurality of first terminals are disposed along the two sides of the inner wall; and the mating ends of the first and second plurality of second terminals are disposed outside the two ends of the inner wall, respectively.

21. A plug connector (e.g., 1) comprising a housing (e.g., 11) comprising first and second outer walls facing each other, third and fourth outer walls joining the first and second outer walls and facing each other, a cavity at least partially bounded by the first, second, third and fourth outer walls, and first and second inner walls (e.g., 112) disposed in the cavity, the cavity comprising a first slot (e.g., 802) between the first inner wall and the first outer wall, a second slot (e.g., 804) between the first inner wall and the second inner wall, and a third slot (e.g., 802) between the second inner wall and the second outer wall; and a plurality of terminals, each of the plurality of terminals comprising a mating end disposed in the second slot of the cavity and along the first inner wall, a tail end extending out of the cavity of the housing, and an intermediate portion between the mating end and the tail end.

22. The plug connector of aspect 21, wherein each of the first, second, and third slots extend in a first direction (e.g., X direction); and the cavity comprises fourth and fifth slots (e.g., 806) disposed on opposite sides of the first, second, and third slots, each of the fourth and fifth slots extending in a second direction (e.g., Y direction) perpendicular to the first direction.

23. The plug connector of aspect 22, wherein the plurality of terminals are a plurality of first terminals (e.g., 13); and the plug connector comprises a plurality of second terminals (e.g., 12), each of the plurality of second terminals comprising a mating end disposed in the fourth slot and along the third outer wall, a tail end extending out of the cavity of the housing, and an intermediate portion between the mating end and the tail end.

24. The plug connector of aspect 23, wherein the plurality of first terminals are configured for signal transmission; the mating ends of the plurality of first terminals are aligned in the first direction; the plurality of second terminals are configured for power transmission; and the mating ends of the plurality of second terminals are aligned in the second direction.

25. The plug connector of aspect 24, wherein the plurality of first terminals are a first plurality of first terminals; the plurality of second terminals are a first plurality of second terminals; and the plug connector comprises a second plurality of first terminals and a second plurality of second terminals, each of the second plurality of first terminals comprising a mating end disposed in the second slot of the cavity and along the second inner wall, each of the plurality of second terminals comprising a mating end disposed in the fifth slot and along the fourth outer wall.

26. The plug connector of aspect 25, wherein the first inner wall is connected to the first outer wall at a bottom of the first slot and corresponding to intermediate portions of the first plurality of first terminals; and the second inner wall is connected to the second outer wall at a bottom of the second slot and corresponding to intermediate portions of the second plurality of first terminals.

27. A board-to-board connector system, comprising a receptacle connector (e.g., 2) comprising: a receptacle housing comprising first and second outer walls (e.g., 211) facing each other, third and fourth outer walls (e.g., 211) joining the first and second outer walls and facing each other, an inner wall (e.g., 224), a first slot (e.g., 212) between the first outer wall and the inner wall, and a second slot (e.g., 212) between the second outer wall and the inner wall; and a plug connector (e.g., 1) comprising a plug housing comprising a plurality of outer walls configured to be disposed outside the outer walls of the receptacle connector, and first and second inner walls (e.g., 112) configured to insert into the first and second slots of the receptacle connector in a mating direction a distance that can vary in a range of 0 to 0.6 mm.

28. The board-to-board connector system of aspect 27, wherein the plug housing comprise a first slot (e.g., 804) between the first and second inner walls and elongated in a first direction (e.g., X direction), second and third slots (e.g., 806) on opposite sides of the first slot and elongated in a second direction (e.g., Y direction) perpendicular to the first direction; the inner wall of the receptacle housing is configured to be disposed in the first slot of the plug housing; and the third and fourth outer walls are configured to be disposed in the second and third slots of the plug housing, respectively.

29. The board-to-board connector system of aspect 28, wherein the plug connector comprises a plurality of plug signal terminals (e.g., 13) and plurality of plug power terminals (e.g., 12), each of the plurality of plug signal terminals comprising a mating end disposed in the first slot and along the first or second inner wall, each of the plurality of plug power terminals comprising a mating end disposed in the second or third slots.

30. The board-to-board connector system of aspect 29, wherein the receptacle connector comprises a plurality of receptacle signal terminals (e.g., 23) and a plurality of receptacle power terminals (e.g., 22), each of the plurality of receptacle signal terminals comprising a mating end disposed on a side of the inner wall, each of the plurality of receptacle power terminals comprising a mating end disposed outside the third or fourth outer walls; intermediate portions of the plurality of receptacle signal terminals are movable in the second direction (e.g., Y direction); and intermediate portions of the plurality of receptacle power terminals are movable in both the first direction (e.g., X direction) and the second direction (e.g., Y direction).

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front”, “rear,” “upper,” “lower,” “left,” “right,” “transverse direction,” “vertical direction,” “perpendicular,” “horizontal,” “top,” “bottom” and the like are shown based on the accompanying drawings, for the purposes of the case in describing the present disclosure and simplification of its descriptions. Unless stated to the contrary, these orientation words do not indicate or imply that the specified apparatus or clement has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on,” “above,” “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features.” Thus, the exemplary term “above” can encompass both the orientations of “above” and “below.” In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value. For example, a phrase “between about 10 and about 20” is intended to mean “between exactly 10 and exactly 20” in some embodiments, as well as “between 10±d1 and 20±d2” in some embodiments. The amount of variation d1, d2 for a value may be less than 5% of the value in some embodiments, less than 10% of the value in some embodiments, and yet less than 20% of the value in some embodiments. In embodiments where a large range of values is given, e.g., a range including two or more orders of magnitude, the amount of variation d1, d2 for a value could be as high as 50%. For example, if an operable range extends from 2 to 200, “approximately 80” may encompass values between 40 and 120 and the range may be as large as between 1 and 300. When only exact values are intended, the term “exactly” is used, e.g., “between exactly 2 and exactly 200.” The term “essentially” is used to indicate that values are the same or at a target value or condition to within ±3%.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also enables that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A receptacle connector comprising:
a housing comprising a plurality of walls, and a cavity at least partially bounded by the plurality of walls; and
a plurality of terminals, each of the plurality of terminals comprising a mating end, a tail end extending out of the cavity of the housing, and an intermediate portion between the mating end and the tail end, the intermediate portion disposed in the cavity of the housing, the plurality of terminals comprising a plurality of first terminals and a plurality of second terminals, the mating ends of the plurality of first terminals disposed in the cavity, the mating ends of the plurality of second terminals extending out of the cavity of the housing, the intermediate portions of the plurality of first terminals movable in a first direction, and the intermediate portions of the plurality of second terminals movable in both the first direction and a second direction perpendicular to the first direction.

2. The receptacle connector of claim 1, wherein:
each of the plurality of first terminals comprises a plurality of curved segments each curving in the first direction; and
each of the plurality of second terminals comprises a first curved segment curving in the second direction, and a second curved segment curving in the first direction.

3. The receptacle connector of claim 2, wherein:
each of the plurality of curved segments of the plurality of first terminals bends at an obtuse angle.

4. The receptacle connector of claim 2, wherein:
the first curved segment of each of the plurality of second terminals bends at an obtuse angle; and
the second curved segment of each of the plurality of second terminals bends at a right angle.

5. The receptacle connector of claim 4, wherein:
the intermediate portion of each of the plurality of second terminals comprises one or more gaps along its length direction.

6. The receptacle connector of claim 1, wherein:
the plurality of first terminals are configured for signal transmission; and
the mating ends of the plurality of first terminals are aligned in the second direction.

7. The receptacle connector of claim 6, wherein:
the plurality of second terminals are configured for power transmission; and
the mating ends of the plurality of second terminals are aligned in the first direction.

8. The receptacle connector of claim 7, wherein:
a width of a gap between adjacent first terminals of the plurality of first terminals is less than a thickness of the plurality of first terminals.

9. The receptacle connector of claim 8, wherein:
each of the plurality of first terminals is capable of satisfying PCIe Gen 4.0's signal transmission requirements at 16 Gps;
each of the plurality of second terminals is capable of carrying a current of 5 A; and
each of the plurality of terminals is movable in a range of −0.8 mm to +0.8 mm in the first direction.

10. The receptacle connector of claim 9, wherein:
the plurality of first terminals are a first plurality of first terminals;
the plurality of second terminals are a first plurality of second terminals;
the plurality of terminals comprise a second plurality of first terminals and a second plurality of second terminals;
the plurality of walls of the housing are a plurality of outer walls;
the housing comprises an inner wall disposed in the cavity, the inner wall comprising two ends and two sides joining the two ends;
the mating ends of the first and second plurality of first terminals are disposed along the two sides of the inner wall; and
the mating ends of the first and second plurality of second terminals are disposed outside the two ends of the inner wall, respectively.

11. A plug connector comprising:
a housing comprising first and second outer walls facing each other, third and fourth outer walls joining the first and second outer walls and facing each other, a cavity at least partially bounded by the first, second, third and fourth outer walls, and first and second inner walls disposed in the cavity, the cavity comprising a first slot between the first inner wall and the first outer wall, a second slot between the first inner wall and the second inner wall, and a third slot between the second inner wall and the second outer wall; and
a plurality of terminals, each of the plurality of terminals comprising a mating end disposed in the second slot of the cavity and along the first inner wall, a tail end extending out of the cavity of the housing, and an intermediate portion between the mating end and the tail end.

12. The plug connector of claim 11, wherein:
each of the first, second, and third slots extend in a first direction; and
the cavity comprises fourth and fifth slots disposed on opposite sides of the first, second, and third slots, each of the fourth and fifth slots extending in a second direction perpendicular to the first direction.

13. The plug connector of claim 12, wherein:
the plurality of terminals are a plurality of first terminals; and
the plug connector comprises a plurality of second terminals, each of the plurality of second terminals comprising a mating end disposed in the fourth slot and along the third outer wall, a tail end extending out of the cavity of the housing, and an intermediate portion between the mating end and the tail end.

14. The plug connector of claim 13, wherein:
the plurality of first terminals are configured for signal transmission;
the mating ends of the plurality of first terminals are aligned in the first direction;
the plurality of second terminals are configured for power transmission; and
the mating ends of the plurality of second terminals are aligned in the second direction.

15. The plug connector of claim 14, wherein:
the plurality of first terminals are a first plurality of first terminals;
the plurality of second terminals are a first plurality of second terminals; and
the plug connector comprises a second plurality of first terminals and a second plurality of second terminals, each of the second plurality of first terminals comprising a mating end disposed in the second slot of the cavity and along the second inner wall, each of the plurality of second terminals comprising a mating end disposed in the fifth slot and along the fourth outer wall.

16. The plug connector of claim 15, wherein:
the first inner wall is connected to the first outer wall at a bottom of the first slot and corresponding to intermediate portions of the first plurality of first terminals; and
the second inner wall is connected to the second outer wall at a bottom of the second slot and corresponding to intermediate portions of the second plurality of first terminals.

17. A board-to-board connector system, comprising:
a receptacle connector comprising:
a receptacle housing comprising first and second outer walls facing each other, third and fourth outer walls joining the first and second outer walls and facing each other, an inner wall, a first slot between the first outer wall and the inner wall, and a second slot between the second outer wall and the inner wall; and
a plug connector comprising:
a plug housing comprising a plurality of outer walls configured to be disposed outside the outer walls of the receptacle connector, and first and second inner walls configured to insert into the first and second slots of the receptacle connector in a mating direction a distance that can vary in a range of 0 to 0.6 mm.

18. The board-to-board connector system of claim 17, wherein:
the plug housing comprise a first slot between the first and second inner walls and elongated in a first direction, second and third slots on opposite sides of the first slot and elongated in a second direction perpendicular to the first direction;
the inner wall of the receptacle housing is configured to be disposed in the first slot of the plug housing; and
the third and fourth outer walls are configured to be disposed in the second and third slots of the plug housing, respectively.

19. The board-to-board connector system of claim 18, wherein:
the plug connector comprises a plurality of plug signal terminals and plurality of plug power terminals, each of the plurality of plug signal terminals comprising a mating end disposed in the first slot and along the first or second inner wall, each of the plurality of plug power terminals comprising a mating end disposed in the second or third slots.

20. The board-to-board connector system of claim 19, wherein:
the receptacle connector comprises a plurality of receptacle signal terminals and a plurality of receptacle power terminals, each of the plurality of receptacle signal terminals comprising a mating end disposed on a side of the inner wall, each of the plurality of receptacle power terminals comprising a mating end disposed outside the third or fourth outer walls;
intermediate portions of the plurality of receptacle signal terminals are movable in the second direction; and
intermediate portions of the plurality of receptacle power terminals are movable in both the first direction and the second direction.
